(19) United States
(12) Patent Application Publication
(10) Pub. No.: US 2012/0259060 A1
(43) Pub. Date: Oct. 11, 2012

(54) RUBBER COMPOSITION WITH ORGANIC SALT CURING AGENT

(75) Inventor: Xiaofeng Shaw Yang, Simpsonville, SC (US)

(73) Assignee: CGEM and MRT ,S.A.

(21) Appl. No.: 13/518,025

(22) PCT Filed: Dec. 28, 2010
(86) PCT No.: PCT/US2010/062206

§ 371 Date: Jun. 21, 2012

Related U.S. Application Data
(60) Provisional application No. 61/291,227, filed on Dec. 30, 2009.

(51) Int. Cl. C08L 7/00; C08L 9/06

(52) U.S. Cl. 524/575; 524/575.5

(57) ABSTRACT

A rubber composition comprising a metal salt of a carboxylic acid used as a curing agent, a highly unsaturated dieene rubber, a filler and a sulfur vulcanization system of between 0.5 phr and 8 phr of sulfur and at least one vulcanization accelerator. Particular embodiments may further include between 1 phr and 6 phr of a metal salt of a carboxylic acid that increases a tear index of the cured elastomer composition by at least 50 percent as compared to a similar cured elastomer composition, such similar cured elastomer composition being different in composition only in that it (1) lacks the metal salt of a carboxylic acid and (2) has an increased amount of the sulfur vulcanization system at about the same sulfur to accelerator ratio to maintain a 10% modulus of elongation at 23 0C to within 15% of the modulus of the cured rubber composition.

This application claims the benefit of U.S. Provisional Application No. 61/291,227 filed Dec. 30, 2009.

### BACKGROUND OF THE INVENTION

### Field of the Invention

This invention relates generally to rubber compositions and more specifically, to rubber compositions having an organic salt, as a curing agent and articles made therefrom.

### SUMMARY OF THE INVENTION

Particular embodiments of the present invention include a cured rubber composition that is based upon a cross-linkable rubber composition, the cross-linkable rubber composition comprising, per 100 parts by weight of rubber, a highly unsaturated diene rubber, between 20 phr and 150 phr of a filler and a sulfur vulcanization system of between 0.5 phr and 8 phr of sulfur and at least one vulcanization accelerator, the sulfur vulcanization system having a sulfur to accelerator ratio. Particular embodiments further include between 1 phr and 6 phr of a metal salt of a carboxylic acid that increases a tear index of the cured elastomer composition by at least 50 percent as compared to a similar cured elastomer composition in that the similar cured elastomer composition is different in composition only in that the similar cured elastomer composition (1) lacks the metal salt of a carboxylic acid and (2) has an increased amount of sulfur vulcanization system at the same sulfur to accelerator ratio to maintain a 10% modulus of elongation at 23° C. to within 15% of the modulus of the cured rubber composition.

The foregoing and other objects, features and advantages of the invention Will be apparent from the following more detailed descriptions of particular embodiments of the invention.

### DETAILED DESCRIPTION OF PARTICULAR EMBODIMENTS

Particular embodiments of the present invention include a cured rubber composition that is based upon a cross-linkable rubber composition and articles made therefrom, the cross-linkable rubber composition comprising a metal salt of a carboxylic acid that is used as a curing agent. The term “based upon” as used herein recognizes that the rubber compositions and articles made therefrom are of vulcanized or cured rubber compositions that were, at the time of their assembly, uncured or green. The cured composition is therefore “based upon” the uncured rubber composition. In other words, the cross-linked rubber composition is based upon the cross-linkable rubber composition.

It has been discovered that the addition of the metal salt of a carboxylic acid can surprisingly act as a curing agent in a rubber composition having a sulfur vulcanization curing system. Since the metal salt acts as a curing agent, the amount of the sulfur vulcanization curing system can be reduced by an amount sufficient to maintain a similar state of cure in the cured composition. Surprisingly, the physical properties of such a cured rubber composition are significantly improved compared to those of a similar rubber composition lacking the metal salt of the carboxylic acid and having the correspondingly larger quantity of the sulfur vulcanization system.

More particularly, it has been discovered that a rubber composition having the metal salt of the carboxylic acid and the correspondingly reduced quantity of its sulfur vulcanization system may be characterized, for example, as having improved tear resistance, improved cured adhesion to another rubber material and/or improved aged properties when compared to unaged properties. Aged properties are those properties of a rubber composition that has been aged for a period of time while unaged properties are those properties of a rubber composition that has not been aged.

Suitable metal salts of a carboxylic acid useful as a curing agent in particular embodiments of the present invention may particularly include a metal salt of an unsaturated carboxylic acid. Examples of such a suitable salt include zinc dimethacrylate (ZDMA), zinc diacrylate (ZDA), magnesium dimethacrylate, magnesium diacrylate or combinations thereof. Other useful salts used alone or in combination with others may include, for example, a zinc monomethacrylate (ZMMA) or a zinc monoacrylate. Other suitable acrylates as known to those having ordinary skill in the art may be used alone or in combination with other acrylates, including a methacrylate.

More generally, a useful metal salt for inclusion in particular embodiments of the present invention may be made from carboxylic acids such as methacrylic acid, ethacrylic acid, acrylic acid, cinnamic acid, crotonic acid, maleic acid, fumaric acid, itaconic acid, and combinations thereof.

The metal used to form the useful metal salt with the carboxylic acid may include, for example, sodium, potassium, iron, magnesium, calcium, zinc, barium, aluminum, tin, zirconium, lithium, cadmium, cobalt and combinations thereof.

The metal salt of the carboxylic acid may be added as a curing agent to particular embodiments of the rubber compositions in an amount of between 1 and 6 phr. Alternatively, the metal salt may be added in an amount of between 0.5 and 7 phr, between 1 and 5 phr, between 1 and 4 phr or between 1 and 3 phr.

The sulfur vulcanization system cures or vulcanizes the cross-linkable rubber composition when heated in a manner well known to one having ordinary skill in the art. The sulfur vulcanization system includes sulfur and at least one accelerator. Sulfur may be added to the rubber composition in any acceptable form, examples of which include pulverized sulfur, rubber maker's sulfur, commercial sulfur and insoluble sulfur. While not limiting the invention, in particular embodiments the sulfur may be added in an amount of between 0.5 phr and 8 phr or between 1 and 8 phr. Alternatively, the sulfur may be added in an amount of between 1 and 12 phr, between 1 and 10 phr, between 1 and 6 phr, between 1 and 4 phr or between 0.5 and 4 phr or between 0.5 and 6 phr. Other embodiments may include between 0.1 and 2 phr, between 0.2 and 1.5 phr or between 0.1 and 1 phr.

Suitable accelerators may be selected and added in amounts for particular applications by methods well known to one having ordinary skill in the art. Examples of suitable accelerator types include thiazoles, sulfenamides, guanidines, thiourea derivatives, amine derivatives, thiurams, dithiocarbamates, xanthates and combinations thereof. Such accelerators include slow accelerators, moderately fast accelerators, fast accelerators and ultra-accelerators. These include, but are not limited to: benzothiazyl-2-cyclohexyl sulfenamide (CBS), benzothiazoyl-2-tert.-butyl sulfenamide (TBBS), 2-mercaptobenzothiazole (MBT), zinc or sodium salt of 2-mercaptobenzothiazole (ZMBT), benzothiazyl-2-sulphene morpholide (MBS), benzothiazyldicyclohexy-1 sulfenamide (DCBS), diphenyl guanidine (DPG), Triphenyl guanidine (TPG), diorthotolyl guanidine (DOTG), o-tolylbigaunide (OTBG), ethylene thiourea (ETU), diethylthiourea (DETU), diphenyl thiourea (DPTU), benzothiazole disulfide (MBTS), hexamethylene tetramine (HMT), ethylidene aniline (EA), zinc dibenzyl dithiocarbamate (ZBEC), zinc-N-dimethyl-dithiocarbamate (ZDMC), zinc-N-diethyldithio-carbamate (ZDEC), zinc-N-dibutyl-dithiocarbamate (ZDBC), zinc-N-ethylphenyldithiocarba-mate (ZEBC), and mixtures thereof.

Since the metal salt of the carboxylic acid acts as a curing agent, the total amount of sulfur and accelerator added to the cross-linkable rubber composition is reduced to compensate for the vulcanization activity caused by the metal salt. It is the substitution of the metal salt for part of the vulcanization system that provides the surprising improvement in the physical properties of both the aged and unaged rubber compositions. The sulfur and accelerator are reduced in proportion, i.e., the ratio of sulfur to accelerator is maintained at a constant so that when the sulfur is reduced, the accelerator is reduced by an amount to maintain an about constant sulfur to accelerator ratio, e.g., within 4 percent or alternatively within 2 percent or within 0.5 percent. The sulfur to accelerator ratio is sulfur phr/accelerator phr.

More specifically, the sulfur vulcanization system is reduced by an amount that provides the same level of cure in the cured rubber composition as obtained in a similar rubber compOsition lacking the metal salt of the carboxylic acid. Using the measured modulus of elongation of the cured rubber composition, the vulcanization system may be reduced to maintain the modulus within 10% between the two compositions. The modulus of elongation may be measured at 10% (MA10), 100% (MA 100) and at 300% (MA 300) at a temperature of 23° C. based on ASTM Standard D412 on dumb bell test pieces. In some embodiments, all three moduli (MA10, MA100, MA300) are maintained within 10% of each other (with and without the metal salt and altered vulcanization system) while in other embodiments, only one of the moduli or two of the moduli are maintained within 10%.

For example, if the MA10 of the rubber composition lacking the metal salt is 3 MPa, then the rubber composition having the metal salt should have its sulfur vulcanization system reduced by an amount to provide a MA10 of between 2.7 and 3.3 MPa. Alternatively, the MA10 may be maintained within 15%, 12%, 8% or 6%. In particular embodiments, this may be achieved by reducing the sulfur vulcanization system by 40% by weight.

In addition to the metal salt and the sulfur vulcanization system, the rubber compositions further include a highly unsaturated diene rubber. A “diene” elastomer or rubber is understood to mean, generally, an elastomer resulting at least in part (i.e. a homopolymer or a copolymer) from diene monomers having two double carbon-carbon bonds, whether conjugated or not. An “essentially unsaturated” diene elastomer is understood to mean a diene elastomer resulting at least in part from conjugated diene monomers and having a content of units of conjugated diene origin that is greater than 15 mol. %. A “highly unsaturated” diene elastomer falls within the category of an essentially unsaturated diene elastomer but is understood to mean a diene elastomer having a content of units of conjugated diene origin that is greater than 50 mol. %.

An “essentially saturated” diene elastomer is understood to mean a diene elastomer having a low or very low content of units of diene origin, which is always less than 15%. Thus, for example, an elastomer such as a butyl rubber, a copolymer of a diene and of an alpha-olefin of the ethylene-propylene diene terpolymer (EPDM) type or a copolymer of an ethylene-vinyl acetate type do not fall within the definition of an essentially unsaturated diene elastomer. Particular embodiments of a rubber composition in accordance with the present invention do not include any essentially saturated diene elastomer. Other embodiments may optionally include a low quantity of an essentially saturated diene elastomer such embodiments including, for example, less than 1, 3 or 5 wt. % of the total elastomer content.

As known by one having ordinary skill in the art, a highly unsaturated diene elastomer may, for example, be obtained from:

(a)—any homopolymer obtained by polymerisation of a conjugated diene monomer having between 4 and 12 carbon atoms;

(b)—any copolymer obtained by copolymerization of a conjugated diene with each other or with a vinyl-aromatic compound having between 8 and 20 carbon atoms.

Suitable conjugated dienes include, for example, 1,3-butadiene, 2-methyl-1,3-butadiene, 2,3-di(C₁-C₅ alkyl)-1,3-butadienes such as 2,3-dimethyl-1,3-butadiene, 2,3-diethyl-1,3 -butadiene, 2-methyl-3-ethyl-1,3-butadiene, 2-methyl-3-isopropyl-1,3-butadiene, an aryl-1,3-butadiene, 1,3-pentadiene and 2,4-hexadiene. Suitable vinyl-aromatic compounds include, for example, styrene, ortho-, meta- and para-methylstyrene, the conunercial mixture “vinyltoluene”, para-tert.-butylstyrene, methoxystyrenes, chlorostyrenes, vinylmesitylene, divinylbenzene and vinylnaphthalene.

The copolymers may contain between 99% and 20% by weight of diene units and between 1% and 80% by weight of vinyl-aromatic units. The elastomers may have any microstructure, which is a function of the polymerisation conditions used, in particular of the presence or absence of a modifying and/or randomising agent and the quantities of modifying and/or randomising agent used. The elastomers may for example be block, statistical, sequential or microsequential elastomers, and may be prepared in dispersion or in solution; they may be coupled and/or starred or alternatively functionalised with a coupling and/or starring or functionalizing agent.

The rubber elastomers that are useful for particular embodiments of the present invention include natural rubber, essentially unsaturated synthetic rubber or combinations thereof that are curable with a metal salt of a carboxylic acid and a sulfur vulcanization system.

In particular embodiments of the rubber composition, the diene elastomer of the composition is highly unsaturated and may be selected, for example, from a polybutadiene (BR), a synthetic polyisoprene (IR), a natural rubber (NR), a butadiene copolymer, an isoprene copolymer, a styrene-butadiene copolymer (SBR), a butadiene-isoprene copolymer (BIR), an styrene-isoprene copolymer (SIR), a styrene-butadiene-isoprene copolymer (SBIR) and mixtures thereof. Particular embodiments of the rubber composition may include only natural rubber as the highly unsaturated diene elastomer.

Particular embodiments of the rubber composition further include a reinforcing filler, such filler being inorganic, organic or combinations thereof. The inorganic reinforcing filler is to be understood here to mean any inorganic or mineral filler, whatever its color and its origin (natural or synthetic), also referred to as “white” filler or sometimes “clear” filler in contrast to carbon black. Such inorganic filler is capable, on its own, without any other means than an intermediate coupling agent, of reinforcing a rubber composition intended for the manufacturing of a tire tread or other tire component, i.e., is capable of replacing a conventional tire-grade carbon black in its reinforcement function. Such fillers may include, for example, a filler of the siliceous or aluminous type, or a mixture of these two types of fillers.

Carbon black, which is an organic filler, may be used as a sole filler or in combination with one or more inorganic fillers. The compounding amount of the carbon black in the elastomer composition is not limited. In particular embodiments of the present invention, the compounding amount of the carbon black may be up to about 200 phr or between about 10 and about 180 phr. Other useful ranges of carbon black loading may include between 30 and 100 phr in some embodiments of the present invention or between 35 and 70 phr.

Suitable carbon blacks are any carbon blacks, in particular the blacks that are conventionally used in tires and particularly in treads. Non-limitative examples of carbon blacks include, for example, the N115, N134, N234, N330, N339, N343, N347 and N375 carbon blacks. Other useful carbon blacks include, for example, N440, N539, N550, N650, N660, N754 and N765.

For those embodiments that employ silica as a reinforcing filler, the silica (SiO₂) used may be any reinforcing silica known to the person skilled in the art. Particular embodiments include any precipitated or pyrogenic silica having a BET surface area and a specific CTAB surface area both of which are less than 450 m²/g, or from 30 to 400 m²/g. Highly dispersible precipitated silicas (referred to as “HD”) are included in particular embodiments, in particular for those embodiments used for the manufacturing of tires having a low rolling resistance. “Highly dispersible silica” is understood in known manner to mean any silica having a substantial ability to disagglomerate and to disperse in an elastomeric matrix, which can be observed in known manner by electron or optical microscopy on thin sections. As non-limitative examples of such preferred highly dispersible silicas, mention may be made of the silicas BV3380 and Ultrasil 7000 from Degussa, the silicas Zeosil 1165 MP and 1115 MP from Rhodia, the silica Hi-Sil 2000 from PPG, the silicas Zeopol 8715 or 8745 from Huber, and treated precipitated silicas such as, for example, the aluminium-“doped” silicas.

The physical state in which the reinforcing inorganic filler is present is immaterial, whether it is in the form of a powder, micro-beads, granules, balls or any other form.

The amount of reinforcing inorganic filler may be between 0 and 100 phr, or alternatively, for example, between 5 phr and 100 phr or between 5 and 10 phr. The amount of reinforcing inorganic filler is not meant to be limited and may be at any quantity suitable for a particular purpose. The reinforcing inorganic filler may be mixed with a carbon black filler for some applications. In such applications, the amount of carbon black and the amount inorganic filler is adjusted accordingly, as known to one having ordinary skill in the art, to suit the particular purpose.

Particular embodiments of the rubber composition may include a plasticizing oil. Plasticizing oils are useful for lowering the Mooney viscosity of the green rubber mixture so that it can be sufficiently mixed and processed, i.e., mixed well enough to adequately disperse all the components of the rubber composition and then extruded or otherwise processed into desired products. Such oils are well known to one having ordinary skill in the art, are generally extracted from petroleum (although plant oils, e.g., sunflower oil, are also useful) and are classified as being paraffinic, aromatic or naphthenic type plasticizing oil. Examples of such oils include MES and TDAE oils. Alternatively plasticizing resins may be used to lower the Mooney viscosity of the green rubber composition. Such resins are also well known and include, for example, polyterpene resins and polylimonene resins.

Because the metal salt of the carboxylic acid also can act as a plasticizer, for those compositions that contain a plasticizing oil or resin, the amount of the plasticizing material (oil and/or resin) in the comparable cured elastomer composition may be increased by the amount of metal salt added to the composition. In other words, when comparing the moduli of the comparable rubber composition lacking the metal salt to the rubber composition having the metal salt of the carboxylic acid, the amount of plasticizing material in the comparable composition, in particular embodiments, is increased by the amount of metal salt in the rubber composition.

Other additives can be added to the rubber composition disclosed herein as known in the art. Such additives may include, for example, some or all of the following: coupling agents (if an inorganic reinforcing filler is used), antidegradants, antioxidants, fatty acids, waxes, stearic acid, zinc oxide and other accelerators. Examples of antidegradants and antioxidants include 6PPD, 77PD, IPPD and TMQ and may be added to rubber compositions in an amount, for example, of between 0.5 and 5phr. Zinc oxide may be added in an amount, for example, of between 1 and 6 phr or between 2 and 4 phr. Waxes may be added in an amount, for example, of between 1 and 5 phr.

The invention is further illustrated by the following examples, which are to be regarded only as illustrations and not delimitative of the invention in any way. The properties of the compositions disclosed in the examples were evaluated as described below.

Moduli of elongation (MPa) were measured at 10% (MA10), 100% (MA 100) and at 300% (MA 300) at a temperature of 23° C. based on ASTM Standard D412 on dumb bell test pieces. The measurement were taken in the second elongation; i.e., after an accommodation cycle. These measurements are secant moduli in MPa, based on the original cross section of the test piece.

Hysteresis losses (HL) were measured in percent by rebound at 60° C. at the sixth impact in accordance with the following equation:

HL(%)=100 (W₀−W₁)/W₁

where W₀ is the energy supplied and W₁ is the energy restored.

Tear Resistance Index (TR): The tear resistance indices were measured at 100° C. The breaking load (FRD) is in N/mm of thickness and the elongation at break (ARD) in percentage are measured on a test piece of dimensions 10×142×2.5 mm notched in the center with 3 notches spaced about 5 mm apart and each cut to a depth of 3 mm. The testing was done on an Instron 5565 test machine at a crosshead speed of 500 mm/min. The tear resistance index is then provided by the following equation:

TR=(FRD*ARD)/100.

Cyclic Fatigue: Cyclic fatigue testing was conducted on the cured test samples that were dumbbell shaped and 65 mm long. The test was conducted at ambient temperature by imposing cyclic strain from between 0% and 75% on the test pieces. The total number of cycles to failure was recorded for each test sample as the measurement of cyclic fatigue.

Mooney Plasticity (ML 1+4): Mooney Plasticity is measured in accordance with ASTM Standard D1646-04. In general, the composition in an uncured state is molded in a cylindrical enclosure and heated to 100° C. After 1 minute of preheating, the rotor turns within the test sample at 2 rpm, and the torque used for maintaining this movement is measured after 4 minutes of rotation. The Mooney Plasticity is expressed in “Mooney units” (MU, with 1 MU=0.83 Newton-meter).

Composite Cured Static Adhesion: The cured static adhesion is a measure of the force required to separate a composite rubber sample consisting of a test rubber sample and a control rubber sample (tread rubber composition) which have been cured together but separated by an aluminum foil sheet having a window cut in the center. The window measures 40 mm×7 mm. The length, width, and thickness of both the test and control composite parts are 152 mm×22 mm ×5 mm. The test rubber sample and the control rubber sample are cross-linked through the window during curing for 25 minutes at 150° C. The cured rubber composite is secured in the grips of an INSTRON Model 1122 and the force necessary to separate the cross-linked samples is measured.

### Example 1

This example demonstrates the improved physical properties of rubber formulations having a metal salt of a carboxylic acid as a curing agent.

Two thermochemical stages were used to prepare the rubber compositions having the material components shown in Table 1 (amounts shown in phr). The formulations were prepared by mixing the components given in Table 1, except for the sulfur and the curing agents, to 165° C. in a lab-scale Banbury mixer. The mixtures were then dropped and cooled to about ambient temperature. The sulfur and curing agents were then added on a roll mill. Vulcanization was effected at 125° C. for about 40 minutes. The formulations were then tested to measure their physical properties.

TABLE 1
Formulations and Their Physical Properties

| | W1 | F1 |
|---|---|---|
| Formulations | | |
| Natural Rubber | 100 | 100 |
| Plasticizer Oil | 25 | 22 |
| Carbon Black (N347) | 45 | 45 |
| Tackifier Resin | 3 | 3 |
| Additives | 3 | 3 |
| Stearic Acid and Zinc Oxide | 6 | 6 |
| ZDMA | 0 | 3 |
| Accelerators | 2.4 | 1.44 |
| Sulfur | 2.76 | 1.65 |
| Physical Properties | | |
| Uncured Mooney ML(1 + 4) @ 100° C. | 28.5 | 30.3 |
| MA10 @ 23° C. (MPa) | 2.98 | 3.32 |
| MA100 @ 23° C. (MPa) | 1.51 | 1.65 |
| MA300 @ 23° C. (MPa) | 1.56 | 1.73 |
| Hysteresis Losses, % at 60° C. | 16.4 | 18.6 |
| Breaking Load @ 100° C., (N/mm) | 22 | 25 |
| Elongation at Break @ 100° C., (%) | 170 | 177 |
| Tear Resistance Index (TRI) | 38 | 43 |
| Fatigue Life (cycles) | 75,108 | 55,708 |
| Composite Cured Static Adhesion | 86 | 187 |
| Properties After Aging^{†} | | |
| (Expressed as % of values of Unaged Samples) | | |
| MA10 @ 23° C. (MPa) | 3.9% | 26% |
| Hysteresis Losses, % at 60° C. | 15% | 8% |
| Tear Resistance Index (TRI) @ 100° C. | −48% | −21% |
| Fatigue Life | −61% | −26% |

^{†}Aging Conditions: Seven days at 77° C. in non-circulating air oven.

### Example 2

This example further demonstrates the improved physical properties of rubber formulations having a metal salt of a carboxylic acid as a curing agent. Using the same mixing procedure and curing process as described in Example 1, rubber formulations having the material components shown in Table 2 (amounts shown in phr) were prepared. The formulations were then tested to measure their physical properties.

TABLE 2
Formulations and Their Physical Properties

| | W2 | F2 | W3 | F4 | F5 |
|---|---|---|---|---|---|
| Formulations | | | | | |
| Natural Rubber | 100 | 100 | 50 | 50 | 50 |
| Styrene Butadiene Rubber | | | 50 | 50 | 50 |
| Carbon Black (N326) | 80 | 80 | 80 | 80 | 80 |
| Tackifying resin | 1.75 | 1.75 | 1.75 | 1.75 | 1.75 |
| Metal adhesion promoter | 5 | 5 | 5 | 5 | 5 |
| ZDMA | 0 | 3 | 0 | 3 | 3 |
| Zinc Oxide | 7 | 7 | 7 | 7 | 7 |
| Stearic Acid | 0.5 | 0.5 | 0.5 | 0.5 | 0.5 |
| Sulfur | 6 | 6 | 3.2 | 3.2 | 2.6 |
| DPG | | | 0.5 | 0.5 | 0.5 |
| TBBS | 1 | 1 | 2.5 | 2.5 | 2.0 |
| 6PPD | 1.5 | 1.5 | 1.5 | 1.5 | 1.5 |
| Physical Properties | | | | | |
| MA10 @ 23° C. (MPa) | 12.4 | 14.8 | 11.6 | 12.9 | 11.1 |
| MA50 @ 23° C. (MPa) | 6.0 | 7.6 | 6.1 | 6.9 | 5.4 |
| MA100 @ 23° C. (MPa) | 4.8 | 6.7 | 5.5 | 6.6 | 4.9 |
| Hysteresis Losses, % at 60° C. | 34.6 | 34.8 | 36.9 | 38.5 | 38.6 |
| Breaking Load @ | 31 | 27 | 19 | 14 | 25 |
| 100° C., (N/mm) | | | | | |
| Elongation at Break @ | 93 | 72 | 64 | 53 | 83 |
| 100° C., (%) | | | | | |
| Tear Resistance Index (TRI) | 28.7 | 19.8 | 12.4 | 7.5 | 20.8 |

The first two compositions disclosed in Table 2, W2 and F2, are rubber compositions having natural rubber and cured with sulfur. These compositions demonstrate that adding the ZDMA to a composition increases the modulus but has a significant decrease in the tear resistance of the material.

The last three compositions disclosed in Table 2, W3, F4 and F5, are rubber compositions of a 50-50 mix of natural rubber and styrene-butadiene rubber. Comparing W3 and F4 demonstrates again the deleterious effect of adding ZDMA on the tearing resistance of the cured rubber composition. However, when the sulfur vulcanization system is reduced to maintain the same level of curing, e.g., comparing the MA10 results, then the tear resistance is surprising higher for the rubber composition having the metal salt added.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A cured rubber composition that is based upon a cross-linkable rubber composition, the cross-linkable rubber composition comprising, per 100 parts by weight of rubber:
a highly unsaturated diene rubber;
between 20 phr and 150 phr of a filler;
a sulfur vulcanization system of between 0.5 phr and 8 phr of sulfur and at least one vulcanization accelerator, the sulfur vulcanization system having a sulfur to accelerator ratio; and
between 1 phr and 6 phr of a metal salt of a carboxylic acid that increases a tear index of the cured elastomer composition by at least 50 percent as compared to a similar cured elastomer composition, wherein the similar cured elastomer composition is different in composition only in that the similar cured elastomer composition (1) lacks the metal salt of a carboxylic acid and (2) has an increased amount of the sulfur vulcanization system at about the same sulfur to accelerator ratio, the amount increased to maintain a 10% modulus of elongation at 23° C. to within 15% of the modulus of the cured rubber composition.

2. The cured rubber composition of claim 1, wherein the metal salt is selected from zinc dimethacrylate, zinc diacrylate or combinations thereof.

3. The cured rubber composition of claim 1, wherein the metal salt is selected from magnesium dimethacrylate, magnesium diacrylate or combinations thereof.

4. The cured rubber composition of claim 1, wherein the metal salt of the carboxylic acid is selected from a salt of a metal that is selected from sodium, potassium, iron, magnesium, calcium, zinc, barium, aluminum, tin, zirconium, lithium, cadmium or cobalt.

5. The cured rubber composition of claim 1, wherein the metal salt of a carboxylic acid is in an amount of between 1 phr and 4 phr.

6. The cured rubber composition of claim 1, further comprising:
between 1 phr and 40 phr of a plasticizing material.

7. The cured rubber composition of claim 6, wherein the similar cured elastomer composition is further different in composition by having an increased amount of the plasticizing material equal to the quantity of metal salt added to the cured rubber composition.

8. The cured rubber composition of claim 7, wherein the 10% Modulus of elongation at 23° C. is maintained to within 10% of the modulus of the cured rubber composition.

9. The cured rubber composition of claim 1, wherein the highly unsaturated diene rubber is natural rubber.

10. The cured rubber composition of claim 1, wherein the highly unsaturated diene rubber is a synthetic rubber selected from polybutadiene rubber, styrene-butadiene rubber, polyisoprene rubber, copolymers thereof or combinations thereof.

11. The cured rubber composition of claim 1, wherein the sulfur vulcanization system include between 1 phr and 6 phr of sulfur.

12. The cured rubber composition of claim 1, wherein the sulfur vulcanization system includes between 0.5 phr and. 4 phr of sulfur.

13. The cured rubber composition of claim 1, wherein the 10% modulus of elongation at 23° C. is maintained to within 10% of the modulus of the cured rubber composition.

14. The cured rubber composition of claim 13, wherein the 100% modulus of elongation at 23° C. is maintained to within 10% of the modulus of the cured rubber composition.

15. The cured rubber composition of claim 1, wherein the 100% modulus of elongation at 23° C. is maintained to within 10% of the modulus of the cured rubber composition.

16. A tire having a component made of the cured rubber composition of claim 1.
